(19) United States
(12) Patent Application Publication
(10) Pub. No.: US 2025/0286333 A1
(43) Pub. Date: Sep. 11, 2025

(54) CORE FOR LIGHTING SYSTEM

(71) Applicant: A.A.G. Stucchi S.R.L., Olginate (IT)

(72) Inventor: Aristide Stucchi, Olginate (LC) (IT)

(21) Appl. No.: 18/858,539

(22) PCT Filed: Apr. 17, 2023
(86) PCT No.: PCT/IB2023/053901

§ 371 Date: Oct. 21, 2024

(30) Foreign Application Priority Data
Apr. 21, 2022 (IT) 102022000007853

(51) Int. Cl. H01R 25/14; F21V 23/06

(52) U.S. Cl. CPC H01R 25/145; F21V 23/06; H01R 2201/26

(57) ABSTRACT

The core according to the present invention serves for lighting 5 systems, for example electrified guides; the core is made of electrical insulating material, it develops along a longitudinal direction and comprises a portion with a “U” or “C” shaped cross-section defining a recess which develops along the longitudinal direction; the core houses a plurality of electrical conductors so 10 as to be facing the recess; the recess is adapted to receive and couple with box-shaped connection apparatuses for lighting systems; the core comprises mechanical fixing means adapted to allow: an elastic fixing of the core to a profile, and coupling and/or decoupling between core and profile by means of reciprocal movements between core and profile in a direction transverse to 15 said longitudinal direction. In particular, the core is designed to be inserted and fixed, mechanically by means of an elastic fixing, in a recess of a profile of an electrified guide which can be fixed to and/or integrated in an internal or external wall for example of a building or of a piece of furniture or of a vehicle.

### FIELD OF THE INVENTION

The present invention concerns a core for lighting systems, in particular for electrified guides for lamps, as well as an electrified guide and a lighting system.

### BACKGROUND OF THE INVENTION

In the lighting sector, electrified guides have become widespread and are adapted to be mechanically and electrically coupled to “connection apparatuses”. The most common “connection apparatuses” include the so-called “adapters” that can constitute components of lamps.

Electrified guides are typically fixed or hung on room walls.

A connection apparatus typically comprises electrical contacts on its external surface which are adapted to contact conductors of the electrified guide so as to receive electrical power from the guide and transmit it for example to an electrical lighting device of a lamp; in this way, the electrical connection is realized. The electrical connection may also concern electrical control signals.

At present, an electrified guide is generally composed of a metal extrudate or extruded piece, typically made of aluminium, which has a “U” or “C” portion. This portion defines a longitudinal groove into which the connection apparatus can be inserted.

In order to ensure the mechanical connection between the guide and the connection apparatus and the support of the connection apparatus by the guide, the “U” or “C” portion has a particular shaping adapted to cooperate with one or more portions of the connection apparatus; it is in particular the shaping of the groove. The shaping of the guide, in particular the groove, can allow the provision of further functions; for example, it can ensure the correct insertion of the connection apparatus (right direction) or allow the insertion of only suitable apparatuses, preventing instead apparatuses incompatible with the guide itself from being inserted.

Furthermore, to ensure the electrical connection between the guide and the connection apparatus, the “U” or “C” portion typically has at least two cavities, suitably shaped and generally arranged on the two facing sides of the groove. Each of these cavities is adapted to receive an element made of plastic material on which electrical conductors of the guide are fixed; in this way the conductors face the groove of the guide. In use, i.e. when the connection apparatus is inserted in the groove, the electrical contacts of the connection apparatus are in contact with the electrical conductors of the guide.

To ensure a good mechanical coupling/decoupling between the apparatus and the guide, a good electrical coupling/decoupling between the apparatus and the guide, a good mechanical support of the apparatus by the guide, and a good transmission of electrical power and electrical signals from the guide to the apparatus, firstly the various components must be carefully designed and sized and then the metal extrudate and the plastic elements (with the relative electrical conductors) must be carefully assembled by the manufacturer of the electrified guide. For the purposes of the present invention, the drawing and sizing of the guide is of particular interest.

Moreover, the external design of the electrified guide affects the use and/or the aesthetic appearance of the product and therefore, currently, the manufacturers of electrified guides must have in their catalogue many different models to meet the needs of the architectural designers, and, for each model, preferably various colours. Furthermore, if an architectural designer wished an electrified guide with a particular aesthetic form and/or colour, he should turn to a manufacturer of guides to have them designed and produced. As far as colour is concerned, the (obvious) solution of painting or repainting electrified guides after they have been produced and delivered would give poor quality results and would require an expensive masking of the electrical conductors of the guide to prevent them from being covered in whole or in part during the painting process.

### SUMMARY

General object of the present invention is to make the customization of the lighting system easier and/or faster.

A first more specific object of the present invention is to enable manufacturers of lighting systems, including lighting systems integrated in other apparatuses, to carry out the customization themselves.

A second more specific object of the present invention is that the customization does not lead to worsening in performance, in particular worsening in the mechanical and/or electrical connection/disconnection of the connection apparatuses, or even to malfunctions.

This general object as well as these and other more specific objects are achieved thanks to what is expressed in the appended claims which form an integral part of the present description.

### LIST OF FIGURES

The present invention shall become more readily apparent from the detailed description that follows to be considered together with the accompanying drawings in which:

FIG. 1 shows a view in cross-section of an electrified guide for lighting systems according to the prior art,

FIG. 2 shows a view in cross-section of a connection apparatus for lighting systems, in particular of a so-called “adapter”,

FIG. 3 shows a cross-sectional view of the adapter of FIG. 2 coupled to the guide of FIG. 1,

FIG. 4 shows a sectional view in cross-section of an embodiment example of a core for lighting systems according to the present invention,

FIG. 5 shows a sectional view in cross-section of an embodiment example of a profile according to the present invention,

FIG. 6 shows a sectional view in cross-section of the core of FIG. 4 coupled to the profile of FIG. 5,

FIG. 7 shows a transverse view of the adapter of FIG. 2 coupled to the coupling of the core of FIG. 4 and of the profile of FIG. 5,

FIG. 8 shows a three-dimensional view of a second core (slightly different from that of FIG. 4) and a second profile (slightly different from that of FIG. 5) that are partially coupled (specifically the core is partially fitted in the profile),

FIG. 9 shows a three-dimensional view of a third core (slightly different from that of FIG. 4) and of a third profile (slightly different from that of FIG. 5) that are partially coupled (specifically the core is partially fitted in the profile),

FIG. 10 shows a three-dimensional view of a fourth core (different from that of FIG. 4) and of a fourth profile (different from that of FIG. 5) that are partially coupled (specifically the core is partially fitted in the profile),

FIG. 11 shows a three-dimensional view of a fifth core (different from that of FIG. 4) and of a fourth profile (different from that of FIG. 5) that are partially coupled (specifically the core is partially fitted in the profile),

FIG. 12 shows a series of profiles according to the present invention different, but all adapted to be coupled to the same core,

FIG. 13 shows a cross-sectional view of a first particularly advantageous embodiment example (first variant) of an electrified guide according to the present invention,

FIG. 14 shows a three-dimensional view of the guide of FIG. 13,

FIG. 15 shows a cross-sectional view of the guide of FIG. 13 in which a connection apparatus is inserted,

FIG. 16 shows a cross-sectional view of a first particularly advantageous embodiment example (second variant) of an electrified guide according to the present invention,

FIG. 17 shows a cross-sectional view of a second particularly advantageous embodiment example of an electrified guide according to the present invention with a coupled connection apparatus,

FIG. 18 shows a cross-sectional view of a third particularly advantageous embodiment example of an electrified guide according to the present invention with a coupled connection apparatus,

FIG. 19 shows views in cross-section of ribs and grooves suitable for the present invention,

FIG. 20 shows a view in cross-section of a first particular embodiment of a core according to the present invention, and

FIG. 21 shows a view in cross-section of a second particular embodiment example of a core according to the present invention.

FIG. 22 shows the core of FIG. 20 coupled with, for example, an embodiment of a profile according to the present invention in two positions, and

FIG. 23 shows the core of FIG. 21 coupled with, for example, an embodiment of a profile according to the present invention.

As can be easily understood, there are various ways of practically implementing the present invention which is defined in its main advantageous aspects in the appended claims and is not limited either to the following detailed description or to the appended claims.

### DETAILED DESCRIPTION

The idea underpinning the present invention is to separate the electrified guide into a first part that incorporates the characteristics (preferably all the characteristics) that impact on the operation of the guide (i.e. on the coupling of the guide with connection apparatuses), which for simplicity can be called the “technical part”, and a second part that incorporates the characteristics 20 that impact on the use and/or the aesthetics of the guide, which for simplicity can be called the “aesthetic part” (without excluding aspects linked to use); preferably, the operation of the guide is considered both from a mechanical point of view and from an electrical point of view.

In doing so, the same “technical part” can be combined with a multiplicity of 25 different “aesthetic parts”. Not only that, in doing so the manufacturer of electrified guides can even afford to provide some customers with only the “technical part” and let customers freely design the “aesthetic part” without fear that the mechanical and/or electrical performance of the electrified guide will worsen or that malfunctions will occur.

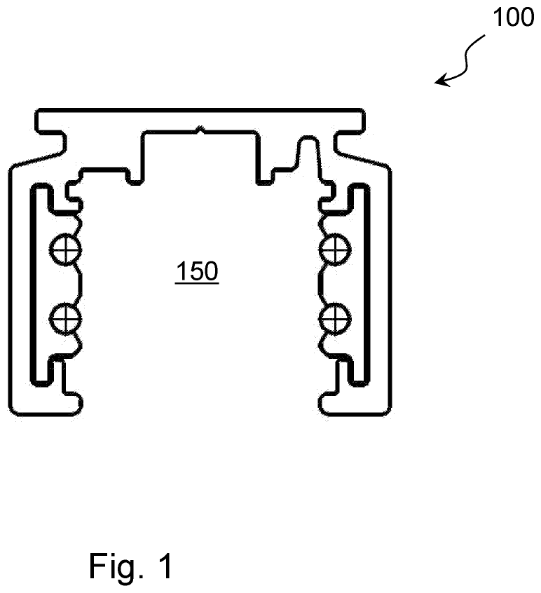

FIG. 1 shows a cross-sectional view of an electrified guide 100 for lighting systems according to the prior art; it develops along a longitudinal direction and comprises a portion with a “U” or “C” shaped cross-section defining a recess 150 (which may also be called a “groove”) which also develops along the longitudinal direction. It has been said that the section is in the shape of a “C” since in the external zone of the recess 150 there are two elements that protrude (specifically slightly) towards the inside of the recess and therefore make the section resemble more a “C” than a “U” (consider in particular only the extrudate). The guide 100 is adapted to be fixed for example to an internal wall of a building.

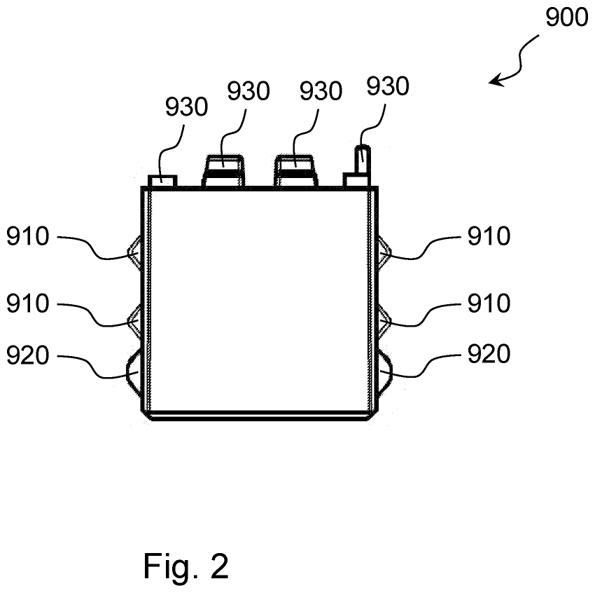

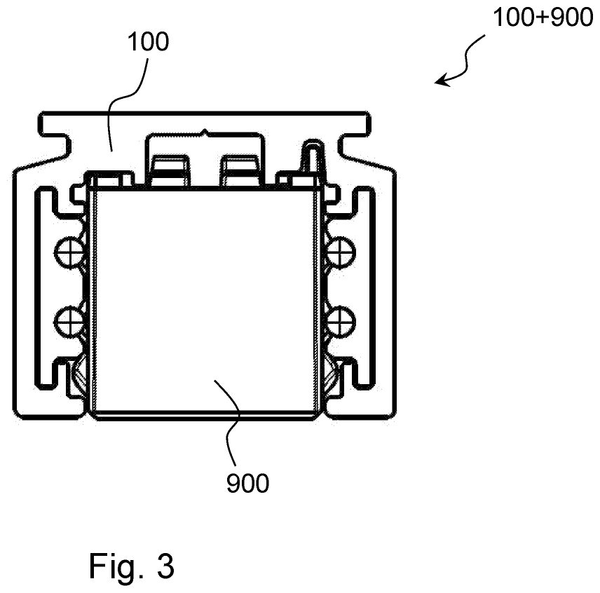

The recess 150 is configured to receive and couple with a connection apparatus for lighting systems such as that shown in FIG. 2 and indicated with 900, which is commonly named “adapter”; the recess has a particular shaping adapted to cooperate with one or more portions of the connection apparatus. The electrified guide 100 of FIG. 1 is composed of a metal extrudate, for example in aluminium, with a groove and two cavities suitably shaped and arranged on the two facing sides of the groove; each of the two cavities accommodates a plastic element on which two electrical conductors facing the groove of the guide are fixed. When the connection apparatus is inserted in the groove of the guide, as shown in FIG. 3, the electrical contacts of the connection apparatus (900) are in contact with the electrical conductors of the guide (100) and there is thus electrical contact. Not only that, when the connection apparatus is inserted in the groove of the guide, as shown in FIG. 3, two lateral protrusions (920) of the connection apparatus (900) are in contact with two lateral recesses of the guide (100), in particular the protrusions are inserted in the recesses, and there is thus mechanical contact and support of the apparatus by the guide.

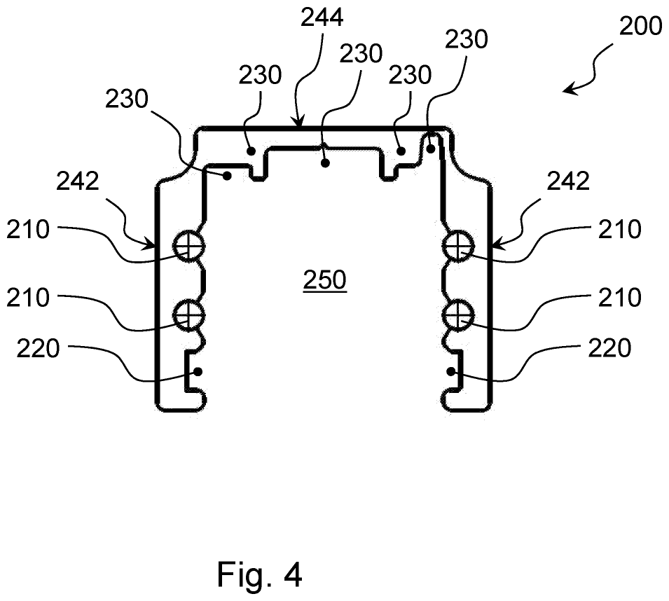

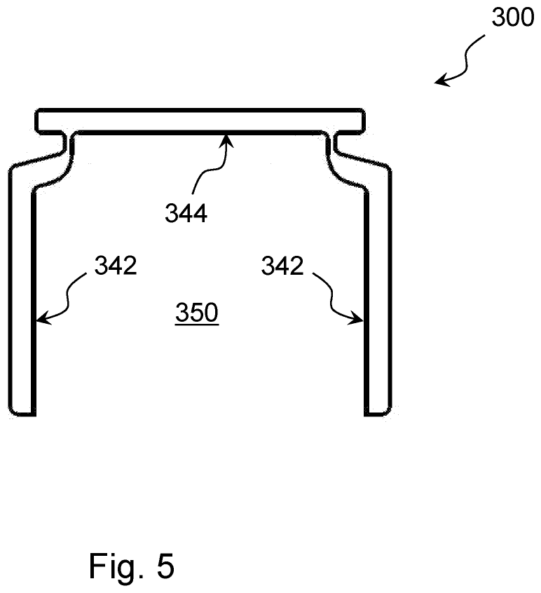

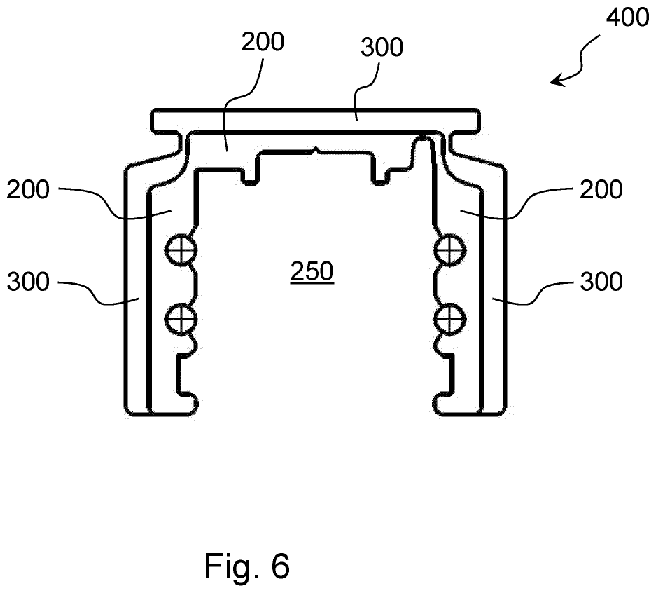

According to the present invention, the guide 100 of FIG. 1 may be realized differently and better, for example as mechanical coupling of a core 200 (see FIG. 4) and of a profile 300 (see FIG. 5) thus realizing a new electrified guide 400 (see FIG. 6) other than the guide 100 (see FIG. 1). Using the terminology introduced above, the core 200 may be called the “technical part” and the profile 300 may be called the “aesthetic part”.

The mechanical coupling between core and profile by means of an elastic fixing (see for example FIG. 6 is not critical as all technical criticalities are preferably concentrated in the core; these criticalities are linked to the elements needed for the mechanical coupling and/or the electrical coupling with connection apparatuses. Conversely, in known electrified guides (see for example FIG. 1), the components must be coupled and positioned with great care, otherwise there may be problems of mechanical and/or electrical coupling between guide and connection apparatuses.

The core for lighting system according to the present invention will be illustrated below with reference to the figures from FIG. 4 to FIG. 7, but this reference is not to be intended in a limiting sense.

The core 200 develops along a longitudinal direction and comprises a portion with a “U” shaped (alternatively “C” shaped) cross-section defining a recess 250 which also develops along the longitudinal direction. As already mentioned, the two alternative embodiments above are to be understood as schematic forms and do not differ much; the difference depends essentially on the configuration and/or size of the external zone of the recess with respect to the internal and/or intermediate zone of the recess. It should be noted that in the example of the figures from FIG. 4 to FIG. 7 the core 200 practically coincides with the U/C-shaped portion, i.e. there are no other portions; but according to alternative embodiment examples, the core could also comprise other portions that are fixed to or integrated with the U/C-shaped portion and could therefore give rise to overall shapes of the core other than the U/C.

The core 200 houses a plurality of electrical conductors 210 so as to be facing onto the recess 250. In FIG. 4, there are for example four electrical conductors (for example two on a first side and two on a second side opposite the first); two of these conductors can be used for example to conduct electrical power from the guide and two of these conductors can be used for example to conduct electrical control signals; differently from what is shown in FIG. 4, the conductors for the control could have a lower section than the conductors for power.

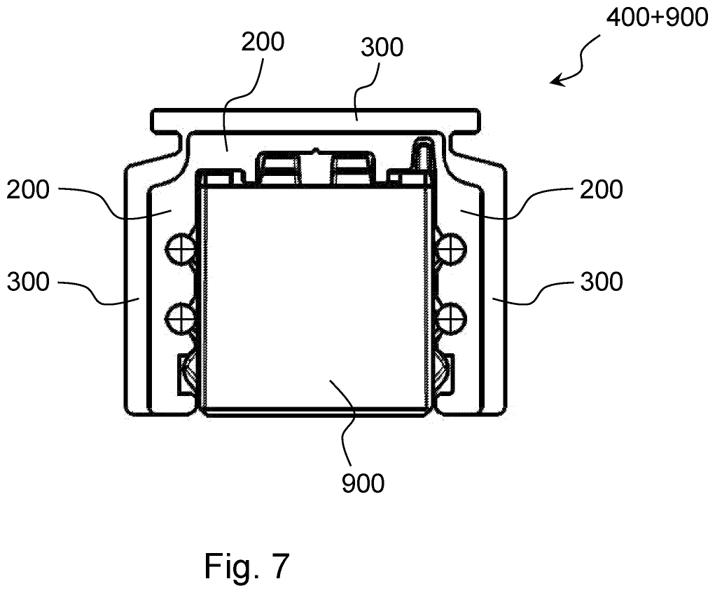

The recess 250 of FIG. 4 is adapted to receive and couple with box-shaped connection apparatuses for lighting systems, for example the “adapter” 900 of FIG. 2 (FIG. 7 shows for example the adapter 900 inserted in the recess 250 and coupled to the core 200, more generally to the electrified guide 400, combination of core 200 and profile 300).

This is a coupling made on the inside of the core (for example, in the figures, between protrusion 920 and recess 220).

Instead, on the outside of the core (see for example the core 200 in FIG. 4 and FIG. 6), a coupling is made, for example, with a profile (see, for example, the profile 300 in FIG. 5 and the resulting coupling 400 in FIG. 6). When the coupling is completed, the core may be completely enclosed or surrounded externally by the profile, in particular surrounded on three external sides as shown in FIG. 6 or even partially surrounded on the fourth side, however leaving room for the insertion of connection apparatuses.

The core 200 (generally a core according to the present invention and therefore adapted to be coupled to a profile) is made of electrical insulating material (or rather essentially of electrical insulating material) such that its electrical conductors 210 are electrically insulated from each other; in particular, the core 200 (generally a core according to the present invention and therefore adapted to be coupled to a profile) is made of plastic (or rather essentially of plastic) which could be reinforced for example with glass and/or carbon fibres. It cannot be rules out that the core 200 (generally a core according to the present invention and therefore adapted to be coupled to a profile) can contain electrically conductive reinforcing material, for example metal, in order to guarantee adequate electrical insulation to its electric conductors for example by covering the conductive material (in whole or in part) with insulating material. Although “material” has been mentioned in the singular, the use of several different substances cannot be ruled out, for example at different points, in particular taking into account different functions of different points of the core.

The core 200 (generally a core according to the present invention and therefore adapted to be coupled to a profile) comprises mechanical contact means 220 adapted to make mechanical contact with connection apparatuses (e.g. the adapter 900) and to provide support to said apparatuses. The means of the core may be recesses and/or protrusions (e.g., in the figures, the recess 220) and may be adapted to cooperate with means of the apparatuses which may be recesses and/or protrusions (e.g., in the figures, the protrusion 920). In general, the mechanical contact means of the core are located at an external zone and/or an intermediate zone and/or an internal zone (i.e. close to the bottom) of the recess of the core. In the example of FIG. 4, the means 220 are located at an external zone of the recess 250. In the example of FIG. 4, the means 220 are recesses.

Advantageously and preferably, the core 200 (generally a core according to the present invention and therefore adapted to be coupled to a profile) is configured such that the connection apparatuses have mechanical support contact only with the core 200 (see FIG. 7). This does not exclude that there may also be non-support mechanical contacts between the connection apparatus and the profile, for example for aesthetic purposes.

Advantageously and preferably, the core 200 (generally a core according to the present invention and therefore adapted to be coupled to a profile) is configured such that the connection apparatuses have electrical contact only with the core 200 (see FIG. 7). This does not exclude that, in general and according to some embodiments, some connection apparatuses can be adapted for electrical connections also of another type, for example by means of electrical cable.

Typically, the electrical conductors 210 of the core 200 (generally a core according to the present invention and therefore adapted to be coupled to a profile) are placed and/or configured in such a way as to make electrical contact with connection apparatuses (e.g., adapter 900), in particular with electrical contacts (e.g., contacts 910) of said apparatuses.

The core 200 (generally a core according to the present invention and therefore adapted to be coupled to a profile) advantageously comprises at least one recess and/or at least one protrusion (see for example references 230 in FIG. 4) facing onto the recess of the core adapted to cooperate with protuberances and/or protrusions (see for example references 930 in FIG. 2) of connection apparatuses to ensure correct coupling with connection apparatuses; for example, this at least one protuberance and/or at least one recess can serve to ensure a correct direction of insertion of the apparatuses in the cores or a correct combination between models of apparatuses and cores or a correct combination among types of the same model of apparatus and core. Preferably, this at least one protuberance and/or at least one recess is located at the bottom of said recess of the core as shown for example in FIG. 4.

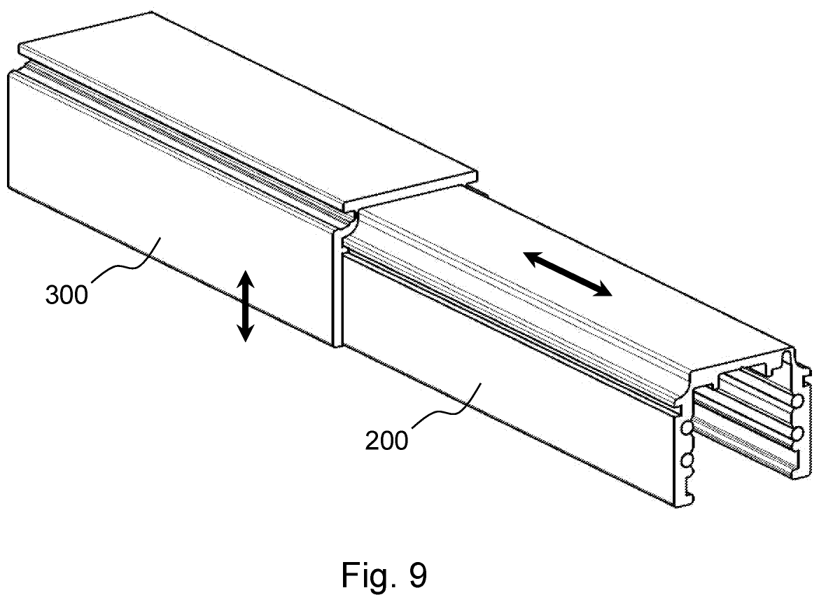

In FIG. 4, the core 200 has (moving from left to right) a first recess, a first protuberance, a second recess, a second protuberance and a third recess, all indicated with the same reference 230. In FIG. 9, correspondingly, the adapter 900 has (moving from left to right) a first protuberance, a second protuberance, a third protuberance and a fourth protuberance, all indicated with the same reference 930 and adapted to cooperate with the recesses and protuberances 230 of the core 200 as shown in FIG. 7.

We now come to consider the coupling made on the outside of the core, that is, the coupling between the core and the profile.

In the figures from FIG. 4 to FIG. 7, no particular means for making such coupling either on the core 200 or on the profile 300) are highlighted, although, as clarified below, there are mechanical fixing means, in particular of small or very small dimensions.

In general, the core (and/or the profile) may also comprise adhesive fixing means adapted to fix the core to a profile in an adhesive manner; according to a first alternative, the adhesive fixing means may comprise recesses adapted to accommodate sticky substance; according to a second alternative, the adhesive fixing means may comprise a layer of adhesive material located on an external surface of the core adapted to contact an internal surface of a profile.

In general, the core comprises mechanical fixing means adapted to fix the core to a profile.

These means are adapted to allow:
an elastic fixing of the core to a profile
coupling and/or decoupling between core and profile by means of reciprocal movements between core and profile (at least) in a direction transverse to said longitudinal direction.

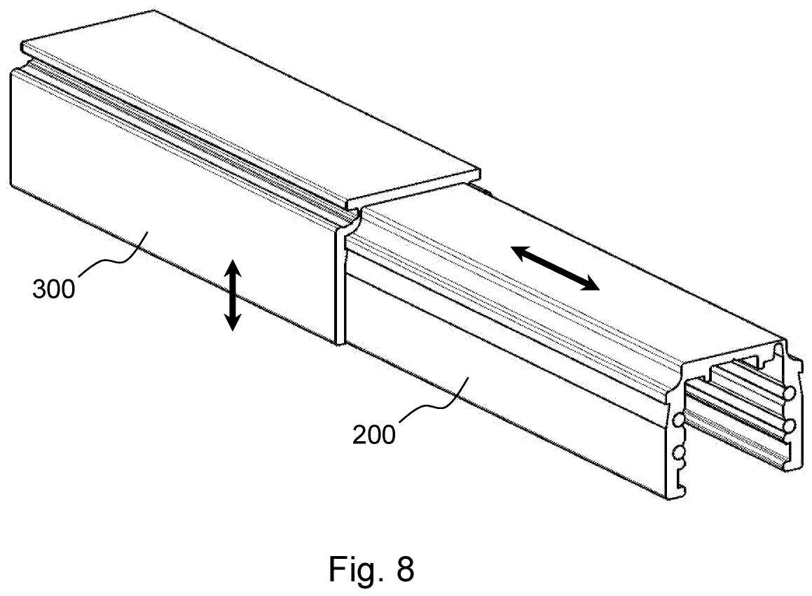

It should be noted that, that, according to the present invention, it is advantageous and typical that coupling and/or decoupling between core and profile can also be realized by means of reciprocal movements between core and profile in a longitudinal direction (for example according to the prior art), as shown for example in FIGS. 8 to 11.

In general, the (mechanical and/or adhesive) fixing means (of the core and/or of the profile) can be located on the flanks and/or on the back, in particular in the case of the core on an external surface of its flanks and/or of its back and in the case of the profile on an internal surface of its flanks and/or of its back. To be clear, in FIG. 4 the external surface of the flanks of this core is indicated with 242 and the external surface of the back of this core is indicated with 244, and in FIG. 5 the internal surface of the flanks of this profile is indicated with 342 and the internal surface of the back of this profile is indicated with 344.

Typically, the mechanical fixing means comprise at least one recess and/or at least one protrusion which is located on the external flanks of the core (see for example reference 242 in FIG. 4). Advantageously, said recess and/or said protrusion is configured and/or dimensioned so to facilitate elastic fixing. Alternatively or in addition, the mechanical fixing means may comprise at least one recess and/or at least one protrusion located on the external surface of the back of the core (see for example reference 244 in FIG. 4).

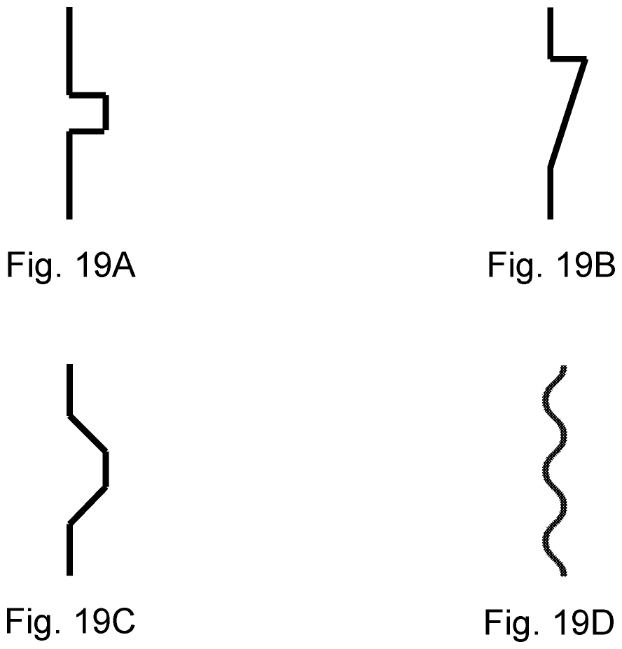

Advantageously, such mechanical fixing means of the core could be grooves and/or ribs (like those shown for example in FIG. 19A having the shape of a square/rectangle, in FIG. 19B having the shape of a triangle, in FIG. 19C having the shape of a trapezium) located on the external surface of the core ((in particular on its external flanks—see for example reference 242 in FIG. 4) and extending, for example, along the longitudinal direction; (the assembly of a plurality of particular grooves and particular ribs may give rise to a wavy surface like the one shown for example in FIG. 19D or a grooved surface).

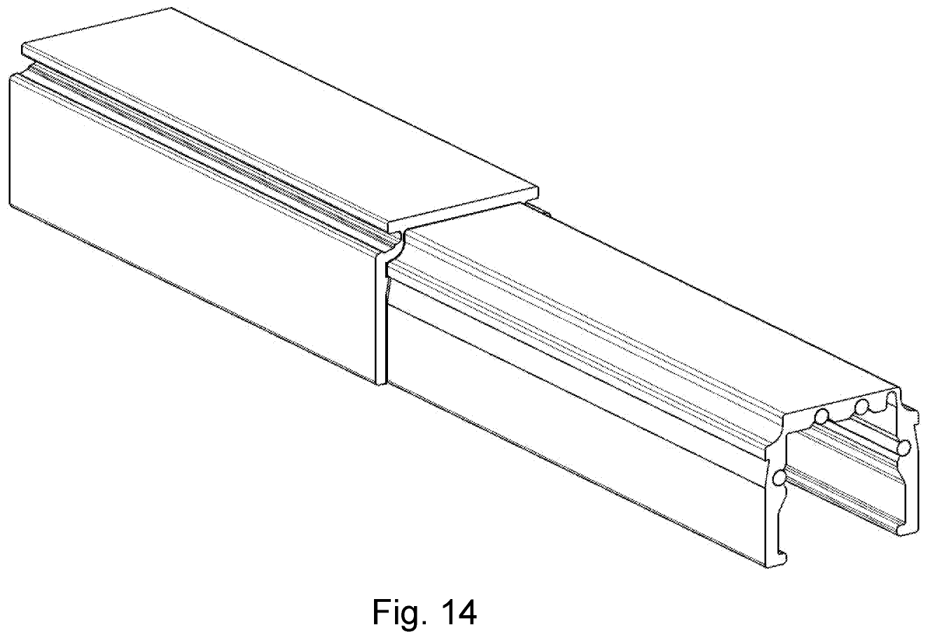

Advantageously, but not necessarily, said ribs and/or grooves are located on the two external flanks of the core and not on the back, as shown in FIGS. 8 to 11 and 13 to 16; such means are also present in the cores of FIGS. 4 to 7 and 17 to 18 even if not evident from the figures themselves.

Typically, there will be corresponding ribs and/or grooves located on the internal surface of the profile (in particular on its internal flanks—see for example reference 342 in FIG. 5) and extending, for example, along the longitudinal direction.

According to the present invention, between these recesses and/or protrusions (in particular grooves and/or ribs) of the core and of the profile there is an elastic cooperation.

The considerations expressed above for the mechanical fixing means and for any fixing adhesive means of the core apply for the mechanical fixing means and for the adhesive fixing means and/or of the profile. It should be noted that, in general, fixing means can be provided on the core and/or on the casing but, preferably, on both.

In the example of FIG. 8, said means of the core 200 consist of two grooves (in particular rigid) with triangular-shaped section and the profile 300 can be elastically deformed (i.e. spread apart) to allow coupling and/or decoupling by means of transverse movements.

In the example of FIG. 9, said means of the core 200 consist of two grooves (in particular rigid) with rectangular-shaped section and the profile 300 can be elastically deformed (i.e. spread apart) to allow coupling and/or decoupling by means of transverse movements.

Alternatively, such mechanical fixing means of the core could be of the elastic type; a first possibility is that the grooves of the core (e.g. those of FIG. 8 and FIG. 9) that are elastic; a second possibility is that the core is provided with elastically deformable teeth.

According to some embodiment examples, the core may comprise metal or magnetic fixing means adapted to fix the core to a profile.

According to some embodiment examples, the core may comprise metal or magnetic means adapted to cooperate with magnetic or metal means of connection apparatuses when the connection apparatuses are inserted into the recess of the core.

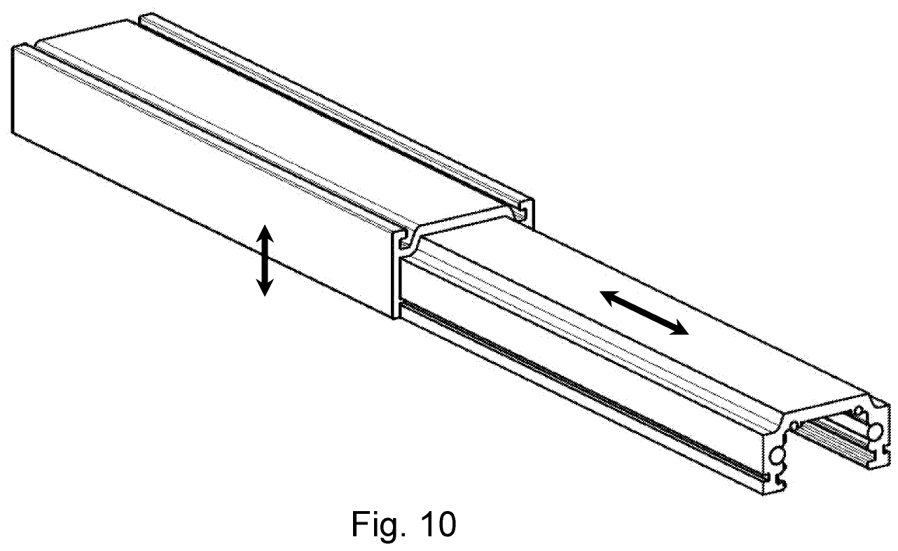

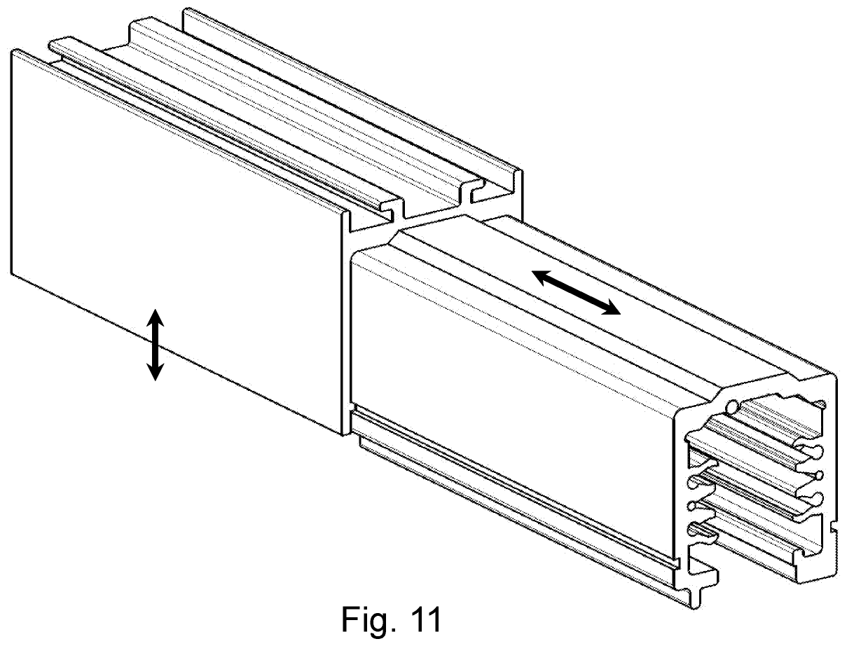

FIG. 10 and FIG. 11 show cores according to the presentation that are rather different from those previously described and shown (with relative possible profiles). Also in this case, however, the profile can be elastically deformed (i.e. spread apart) to allow coupling and/or decoupling by means of transverse movements.

In particular, the core of FIG. 10 has two electrical conductors of electrical power on the two sides of the cavity and two electrical control conductors (with lower section than the power conductors) at the bottom of the cavity. In particular, the core of FIG. 11 has power conductors (in particular four conductors on two opposite sides), control conductors (in particular two conductors on two opposite sides), and a ground conductor (in particular at the bottom of the recess adapted to receive the connection apparatuses). In particular, the power conductors are for mains AC voltage (e.g. 110-120 volts AC or 220-230 volts AC) and the control conductors are for lower DC voltages (e.g. 40-60 volts DC). In particular, the power conductors are backward with respect to the end of the core to avoid risks to those handling the electrified drive.

Coming back now to the profile according to the present invention (consider for example the profile 300 in FIG. 5), it develops along a longitudinal direction (which is typically the same longitudinal direction as the core) and which comprises a “U” or “C” shaped portion; such portion defines a recess (see for example the recess 350 in FIG. 5) which develops along the longitudinal direction; such recess is adapted to receive and fix a core according to the present invention (see for example the coupling of the core 200 and the profile 300 in FIG. 6) mechanically by means of an elastic fixing, thus giving rise to electrified guide (see for example the guide 400 in FIG. 6). The recess can be adapted to fix the core not only mechanically (elastic fixing), but also chemically and/or magnetically.

Typically, according to the present invention the profile comprises mechanical fixing means adapted to allow:
an elastic fixing of the profile to the core, and
coupling and/or decoupling between core and profile by means of reciprocal movements between core and profile (at least) in a direction transverse to a longitudinal direction.

It should be noted that, according to the present invention, it is advantageous and typical that coupling and/or decoupling between core and profile can also be realized by means of reciprocal movements between core and profile in a longitudinal direction (for example according to the prior art), as shown for example in FIGS. 8 to 11.

Advantageously, the mechanical means for fixing the profile comprise at least one recess and/or at least one protrusion that is located on the internal flanks of the profile and that is adapted to elastically cooperate with at least one protrusion and/or at least one recess of the core that is located on the external flanks of the core.

Advantageously, such mechanical fixing means of the profile could be grooves and/or ribs (such as those shown for example in FIG. 19A which has the shape of a square/rectangle, in FIG. 19B which has the shape of a triangle, in FIG. 19C which has the shape of a trapezoid) located on the internal surface of the profile (in particular on its internal flanks—see for example reference 242 in FIG. 4) and extending, for example, along longitudinal direction (the assembly of a plurality of particular grooves and particular ribs can give rise to an undulated surface such as the one shown for example in FIG. 19D or a striped surface). Preferably, said recess and/or said protrusion is configured and/or dimensioned so as to facilitate elastic fixing.

Preferably, the profile is made of a material such as to facilitate elastic fixing by spreading the profile. Alternatively, the mechanical fixing means of the profile are of the elastic type—see the previous description of any mechanical fixing means of the core of the elastic type.

The profile according to the present invention may for example be made of metal and/or plastic and/or wood and/or glass, and may also contain more than one substance.

The profile according to the present invention can be made for example by extrusion or moulding or milling and/or bending; subsequently, the profile can be mounted on the core (in other words, the core can be inserted into the profile).

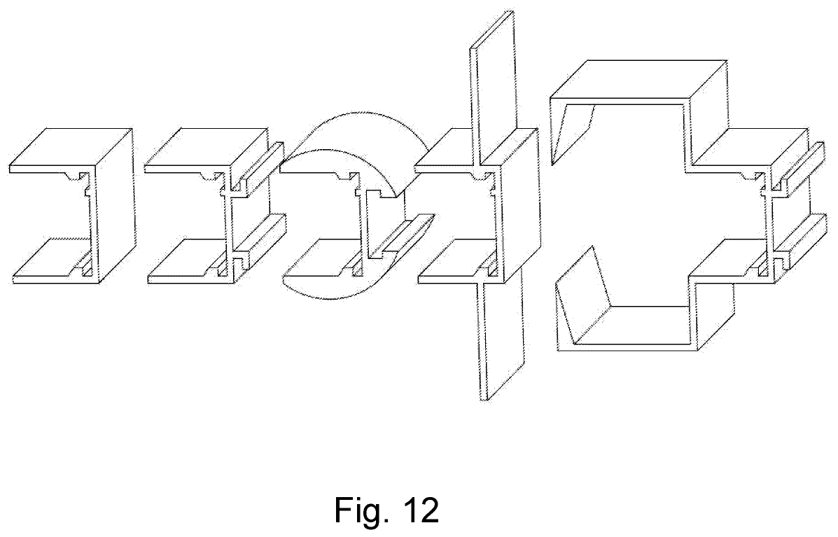

FIG. 12 shows a series of profiles according to the present invention that are different, but all adapted to be coupled to the same core; these profiles have, in particular, two grooves having a trapezoid-shaped section (which can be considered the combination of a rectangle and of a triangle). Four in five profiles shown in this figure also comprise other portions fixed to or integrated with the U/C-shaped portion and thus give rise to overall shapes of the profile that are different from U/C.

As anticipated, the recess of the profile (indicated with 350 in the example of FIG. 5) may be adapted to fix the core also chemically (e.g. by means of substances and/or adhesive means) and/or magnetically. Such fixing can be obtained thanks to means of the profile and/or of the core.

The coupling of the core with the profile can be achieved for example by fitting the core into the profile (in particular into the recess of the profile) in the longitudinal direction, as shown for example by the inclined arrows in the figures from FIG. 8 to FIG. 11.

Alternatively, preferably by suitable configuration and dimension of the core and/or profile and/or parts thereof (and possibly by choice of the material of the profile), the core can be fitted in a direction transverse to the longitudinal direction. FIG. from 8 to 11 also shows the possibility that the core can be fitted into the profile (in particular into the recess of the profile) in the transverse direction indicated by the vertical arrows. For this purpose, it can be envisaged, for example, that the profile is adapted to spread apart slightly when the core is inserted and then to return to the initial position, due to its elasticity, trapping the ribs inside the grooves; a triangular shape of the rib identical or similar to that of FIG. 8 may cause or favour the profile to spread apart while the core is being fitted into the recess.

According to some advantageous embodiments, a profile according to the present invention can be momentarily spread and then return elastically to the initial configuration; depending on the embodiment, the spreading can take place in various ways, for example by effect of a tool in particular a special tool and/or by effect of reciprocal movements between core and profile.

It cannot be ruled out that, according to some embodiments, a core according to the present invention can be momentarily narrowed (in the opposite direction of spreading) and then return elastically to the initial configuration; depending on the embodiment, the narrowing can take place in various ways, for example by effect of a tool in particular a special tool and/or by effect of reciprocal movements between core and profile.

An electrified guide for lighting system according to the present invention essentially comprises a core and a profile.

As described with reference to the embodiment examples of the figures from FIG. 8 to FIG. 11, ribs can be provided to cooperate with grooves in order to fix the core to the profile; ribs can be present on the core and/or on the profile; grooves can be present on the core and/or on the profile. The positions of the ribs and/or of the grooves may vary; for example, according to the embodiment examples of FIG. 8 and FIG. 9 the ribs and the grooves are in an internal zone of the profile and of the core, while according to the embodiment examples of FIG. 10 and FIG. 11 the ribs and the grooves are in an external zone of the profile and of the core. The shape of the section of a groove may not correspond exactly to the shape of the section of a rib; for example the rib may be triangular and the groove may be rectangular as long as the triangle fits into the rectangle.

According to some embodiments, the electrified guide may be fixed (in various ways) to an internal or external wall for example of a building or of a piece of furniture or of a vehicle.

According to other embodiments, the electrified guide may be integrated into an internal or external wall for example of a building or of a piece of furniture or of a vehicle. For example, in this case the profile only can be the one that is integrated, e.g. that is be integral part and the core is coupled/decoupled directly to/from the suitably configured wall.

As it was clear since the beginning of the present description, the most typical application of the present invention is in the lighting sector.

For example, a lighting system may comprise a core like the one just described (see for example that shown in FIG. 4).

For example, a lighting system, in particular a lamp, may comprise an electrified guide like the one just described (see for example that shown in FIG. 6).

As a completion to the present description, some particularly advantageous embodiment examples are described.

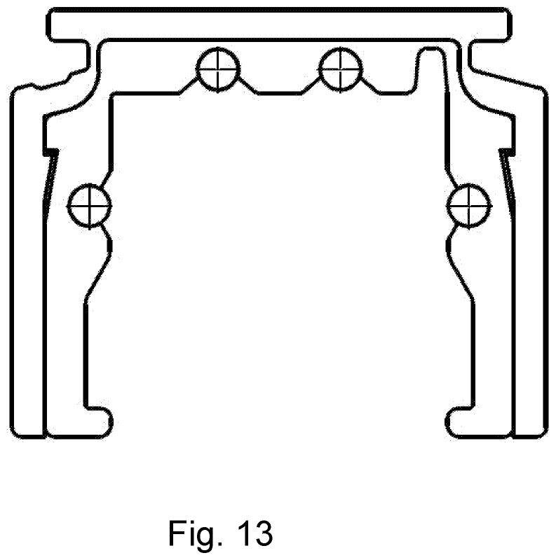

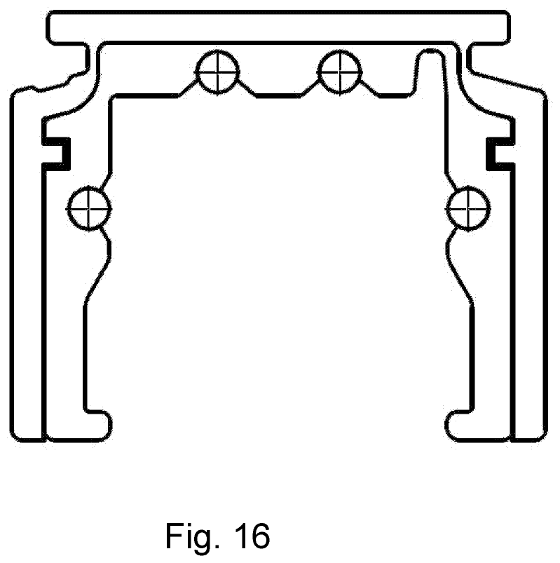

FIGS. 13 to 16 show an electrified guide according to a first particularly advantageous embodiment example in two variants; the first variant is shown in FIGS. 13 to 15 and the second variant is shown in FIG. 16. The two variants differ only in the shape of the section of the two grooves on the two internal sides or flanks of the profile and in the corresponding shape of the two corresponding grooves on the two external sides or flanks of the core; according to the first variant the shape is triangular (it is a rectangular triangle with the vertex facing the outside of the guide) while according to the second variant the shape is square; other variants with different shapes can be thought of.

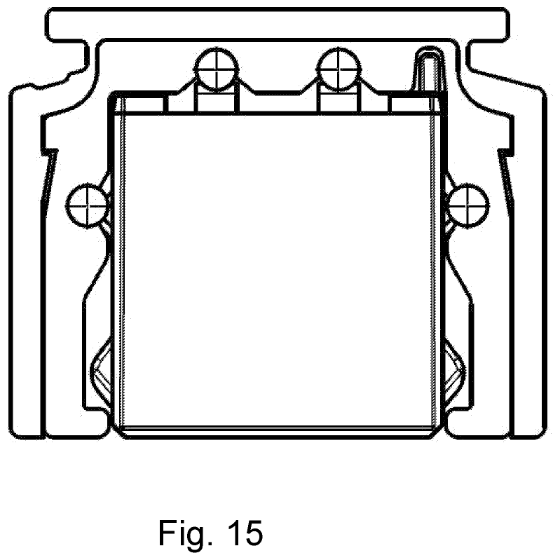

The characteristics of this embodiment example of electrified guide are:
two electrical conductors for control signals at the bottom of the recess of the core
two electrical conductors for electrical power signals on two sides of the recess of the core
two recesses on the two sides or flanks of the recess of the core for mechanical coupling of connection apparatuses with the guide in an external zone of the guide (i.e. at the inlet of the recess)-see in particular FIG. 15
two ribs on the two internal sides or flanks of the profile in an internal zone (with respect to the inlet of the recess) for mechanical elastic coupling between profile and core
two grooves on the two external sides or flanks of the core in an internal zone (with respect to the inlet of the recess) for mechanical elastic coupling between profile and core
a groove at the bottom of the recess of the core in asymmetrical position to allow coupling of the connection apparatus only in one direction and avoid reversals of electrical polarity,
a profile with a fixing plate (see FIGS. 13, 15 and 16 above).

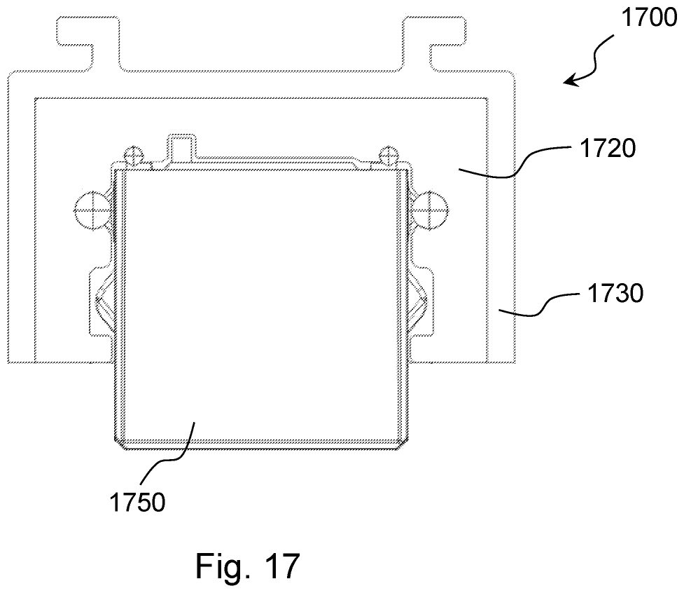

FIG. 17 shows an electrified guide 1700 according to a second particularly advantageous embodiment example with a coupled connection apparatus 1750 (or “adapter”); it may be noted that the guide of FIG. 17 is somewhat similar to the guides of FIG. 13 and FIG. 16.

The electrified guide 1700 comprises a core 1720 and a profile 1730; these are mechanically coupled together.

According to a first characteristic, the apparatus 1750 is only partially within recess of the core 1720.

According to a second characteristic, the apparatus 1750 protrudes slightly from the guide 1700.

According to a third characteristic, the mechanical coupling between apparatus 1750 and guide 1700 is provided by protrusions (or alternatively recesses) of the apparatus 1750 which cooperates elastically respectively with recesses (or alternatively protrusions) of the core 1720.

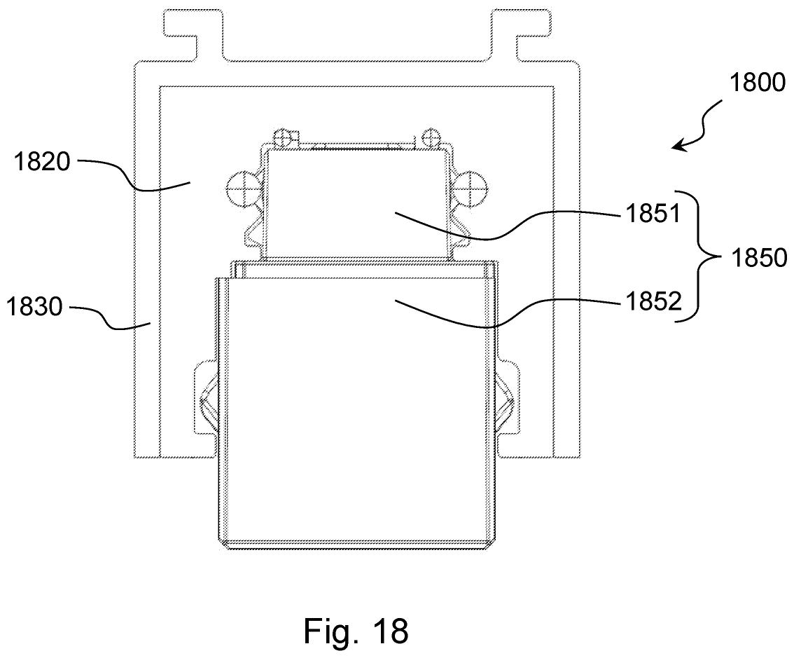

FIG. 18 shows an electrified guide 1800 according to a third particularly advantageous embodiment example with a coupled connection apparatus 1850 (or “adapter”); it may be noted that the guide of FIG. 18 is somewhat similar to the guide of FIG. 17 and somewhat similar to the guides of FIG. 13 and FIG. 16.

The electrified guide 1800 comprises a core 1820 and a profile 1830; these are mechanically coupled together.

According to a first characteristic, the apparatus 1850 is only partially within the recess of the core 1820.

According to a second characteristic, the apparatus 1850 protrudes slightly from the guide 1800.

According to a third characteristic, the mechanical coupling between apparatus 1850 and guide 1800 may be provided by protrusions (or alternatively recesses) of the apparatus 1850 which cooperates elastically respectively with recesses (or alternatively protrusions) of core 1820.

A particularity of the connection apparatus 1850 is that it is composed of a first part 1851 (more internal than the guide) and a of second part 1852 (less internal than the guide). The first part 1851 is adapted to electrically couple with the core 1820, in particular only with the core. The first part 1851 may be adapted to mechanically couple with the core 1820. The second part 1852 may be adapted to mechanically couple with the core 1820; in particular, the second part 1852 is not adapted to electrically couple with the guide 1800. According to this specific embodiment example, the mechanical coupling can be twofold, i.e. to both an internal (e.g. smaller) part of the recess of the core and to an external (e.g. larger) part of the recess of the core; alternatively, it could be coupled to only one part of the recess of the core, e.g. the internal part.

It should be noted that the guide 1800 is adapted to couple with connection apparatuses of different sizes; the different sizes of the apparatuses may allow, for example, different amounts of electronics to be housed inside the apparatuses. A first possible apparatus can correspond for example only to the first part 1851; such apparatus would be totally internal to the core 1820; such apparatus is adapted to couple both mechanically and electrically with the core 1820. A second possible apparatus may correspond for example to the assembly of the first part 1851 and of the second part 1852 (joined together); such apparatus would be only partially internal to the core 1820; such apparatus is adapted to couple both mechanically and electrically with the core 1820. This possibility of different coupling derives in particular from mechanical coupling means provided in the core.

A particularity of the guide 1800 may be, for example, that an electrical apparatus similar to the first part 1851 may be inserted into the guide and mechanically and electrically coupled to the guide and another apparatus may be inserted into the guide and mechanically coupled only to the guide, in particular to the core 1820 in a manner similar to the second part 1852 or to the profile 1830.

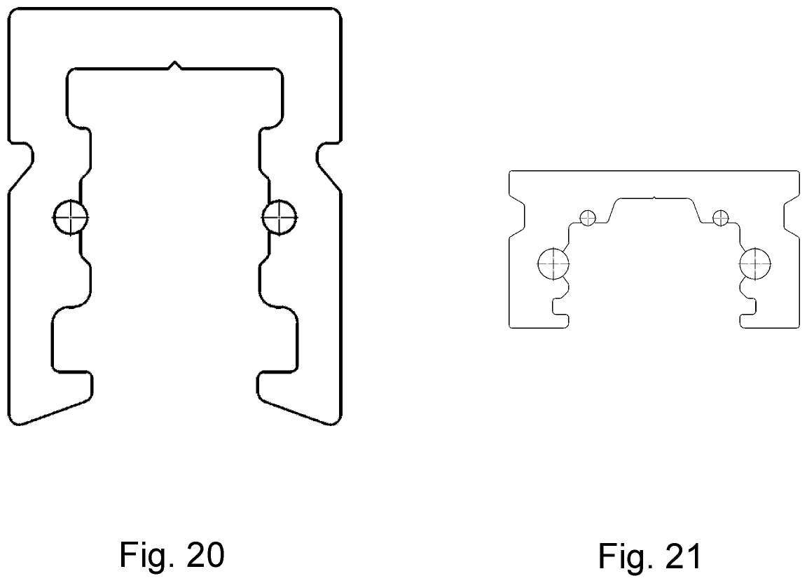

As a completion of the present description, two particular embodiments of cores (for lighting system) according to the present invention are offered which are shown in FIG. 20 and FIG. 21 which comprise mechanical means for elastic fixing; in particular, such means are adapted to fix the core to a profile, are located on the external flanks of the core and are rather backward with respect to the front of the core (alternatively they could be less backward or not backward at all).

In the core of FIG. 20 for example, the grooves have substantially the shape shown in FIG. 19B.

In the core of FIG. 20, for example, there are two electrical conductors.

In the core of FIG. 21, for example, the grooves have substantially the shape shown in FIG. 19C.

In the core of FIG. 21, for example, there are four electrical conductors.

In any case, all the shapes of FIGS. 19 are possible.

In any case, the number and position of electrical conductors can be changed.

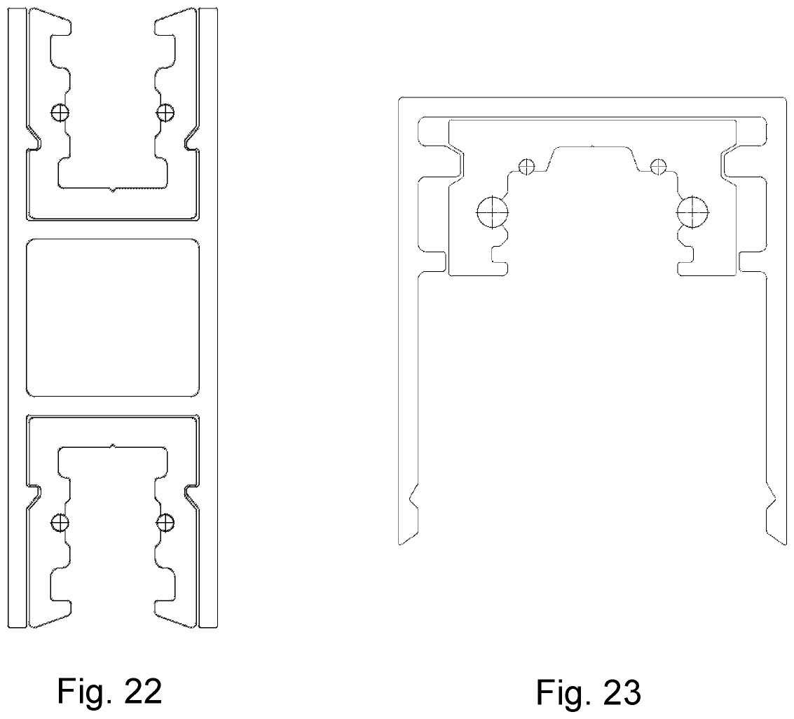

FIG. 22 and FIG. 23 show embodiments of profiles according to the present invention suitable, for example, respectively for the cores of FIG. 20 and FIG. 21. The profile of FIG. 22 is suitable to accommodate two cores. The profile in FIG. 23 is suitable to accommodate one core and has an internal surface that is partly spaced from the external surface of the core.

1. A core for lighting system, the core comprising:
electrical insulating material
which develops along a longitudinal direction and comprises a portion with a “U” or “C” shaped cross-section defining a recess which develops along the longitudinal direction,
wherein said core houses a plurality of electrical conductors so as to be facing onto said recess,
wherein said recess is adapted to receive and couple with box-shaped connection apparatuses for the lighting system;
wherein said core is adapted to allow:
an elastic fixing of the core to a profile, and
coupling or decoupling between core and profile by reciprocal movements between the core and the profile in a direction transverse to said longitudinal direction.

2. The core according to claim 1, further comprising at least one recess or at least one protrusion that is located externally on flanks or on a back of the core and adapted to elastically cooperate with at least one protrusion or at least one recess of the profile located internally on the flanks or on the back of the profile.

3. The core according to claim 2, wherein said at least one recess or said at least one protrusion is configured or dimensioned so as to facilitate elastic fixing.

4. (canceled)

5. The core according to claim comprising a mechanical contact adapted to make mechanical contact with said box-shaped connection apparatuses, and to provide support to said box-shaped connection apparatuses.

6. The core according to claim 5, wherein said core is configured such that said box-shaped connection apparatuses have mechanical support contact only with said core.

7. (canceled)

8. The core according to claim 5, wherein said mechanical contact means is located at an external zone or an intermediate zone or an internal zone of said recess.

9. The core according to claim 5, wherein said electrical conductors are placed or configured in such a way as to make electrical contact with electrical contacts of said box-shaped connection apparatuses.

10. The core according to claim 1, wherein said core comprises at least one recess or at least one protrusion facing onto said recess adapted to cooperate with recesses or protrusions of the box-shaped connection apparatuses to ensure proper coupling with the box-shaped connection apparatuses, said at least one recess or at least one protrusion being located at the bottom of said recess.

11. The core according to claim 1, wherein said core is adapted to fix the core to the profile in an adhesive manner.

12. The core according to claim 11, wherein said core comprises recesses adapted to accommodate a sticky substance.

13. The core according to claim 11, further including a layer of adhesive material located on an external surface of the core adapted to contact an internal surface of the profile.

14. The core according to claim 1, wherein said core comprises a first metal or magnetic fixation adapted to fix the core to the profile.

15. The core according to claim 1, wherein said core comprises a second metal or magnetic fixation adapted to cooperate with a magnetic or metal part of the box-shaped connection apparatuses when said box-shaped connection apparatuses are inserted into said recess.

16. An electrified guide for a lighting system developing along a longitudinal direction and comprising:
a core according to claim 1, and
the profile which develops along the longitudinal direction and which comprises a “U” or “C” shaped portion defining a recess which develops along the longitudinal direction;
wherein said recess is adapted to receive and fix said core mechanically by an elastic fixing.

17. The electrified guide according to claim 16, wherein said recess is adapted to fix said core also chemically and/or magnetically.

18. The electrified guide according to claim 17, wherein said profile is adapted to allow:
an elastic fixing of the profile to the core, and
coupling or decoupling between core and profile by reciprocal movements between core and profile in a direction transverse to said longitudinal direction

19. The electrified guide according to claim 18, wherein said profile comprises at least one recess or at least one protrusion located internally on the flanks or on the back of the profile and adapted to elastically cooperate with at least one protrusion or at least one recess of the core located externally on the flanks or on the back of the core.

20. The electrified guide according to claim 18, wherein said at least one recess or said at least one protrusion is configured or dimensioned so as to facilitate elastic fixing.

21. The electrified guide according to claim 18, wherein said profile is made of a material such as to facilitate elastic fixing by spreading the profile.

22. (canceled)

23. The electrified guide according to claim 16, wherein said profile is made of metal or plastic or wood or glass.

24. The electrified guide according to claim 16, characterized in that it is integrated into a piece of furniture or in an internal or external wall of a building or in a vehicle.

25. A lighting system comprising an electrified guide according to claim 16.
